(19) United States
(12) Patent Application Publication
(10) Pub. No.: US 2011/0184642 A1
(43) Pub. Date: Jul. 28, 2011

(54) FUEL EFFICIENT ROUTING SYSTEM AND METHOD

(75) Inventors: Derek James Rotz, Portland, OR (US); Maik Ziegler, Portland, OR (US)

(73) Assignee: Daimler Trucks North America LLC

(21) Appl. No.: 12/973,764

(22) Filed: Dec. 20, 2010

Related U.S. Application Data
(60) Provisional application No. 61/288,037, filed on Dec. 18, 2009.

(51) Int. Cl. G01C 21/36

(52) U.S. Cl. 701/201

(57) ABSTRACT

A more fuel efficient route between two locations is determined from a plurality of possible different routes and displayed. The different routes can be made up of links or route segments that can begin and end with a node or link transition, each different route comprising at least one different link. In one specific example, a simulation is made utilizing map data, vehicle specific data including mass, traffic congestion and driver driving style characteristics to determine energy values which are stored in association with links and nodes. The stored energy values associated with the links and nodes of plural different routes are then combined, such as by summing, to determine a total energy value for each of the plural different routes. A route having a low energy value is then selected. At least a portion of the route can be displayed to an operator of a vehicle, whereby the operator of the vehicle can follow the displayed route.

### CROSS REFERENCE TO RELATED APPLICATION

This application claims the benefit of U.S. Provisional Patent Application Ser. No. 61/288,037, filed Dec. 18, 2009.

### TECHNICAL FIELD

A method and apparatus is disclosed for determining a more fuel efficient route from a plurality of routes and can be incorporated into a vehicle navigation system.

### BACKGROUND

Navigation systems are widely used by drivers of vehicles for route planning and guidance purposes. Such systems provide drivers with turn-by-turn directions to reach a specified destination. Numerous route optimization algorithms have been developed to select a route based on either minimizing time or minimizing distance from current location to a destination point.

Methods have been developed to determine the shortest route, based solely on summing the net distance of alternative routes from the vehicle's current position to the destination and selecting the route with the least amount of distance.

Other methods determine the fastest route, which is achieved by associating a net travel time with alternate routes based on their distance and allowed speed. The route with the lowest travel time will be selected. The assumption behind the idea is that multiple near-shortest routes exist that may actually be faster due to higher allowed speed limits.

A need exists for improved optimization approaches and route selection systems.

### SUMMARY

For longer distances, typically a large number of possible route combinations to a destination exist, including a significant number of near-shortest and near-fastest routes. Therefore, in accordance with this disclosure, additional criteria relating to energy and/or fuel usage are used in order to select a more appropriate fuel efficient route, or the most fuel efficient route, from a plurality of possible routes. Fuel consumption over a route depends largely upon factors such as road grade, distance, vehicle mass and vehicle speed/acceleration in addition to parameters or characteristics of the vehicle itself that can typically be obtained from vehicle specifications, sensed and/or measured by sensors. Up to now, the determinants of fuel consumption have not been adequately addressed in navigation applications.

Disclosed herein are embodiments of a method and system for determining the energy (which corresponds to fuel) required for a vehicle to travel along a specific route using a model-based approach incorporating vehicle-specific parameters, route-specific parameters, and optionally driver-specific parameters. The proposed method desirably utilizes a model of the vehicle's longitudinal forces to determine an estimate of the energy required for a vehicle to travel a specific route. Route-specific model inputs can include road grade, distance, traffic conditions, traffic controls and speed limits. Furthermore, vehicle mass is incorporated into the model, since it disproportionately influences fuel consumption, particularly with respect to terrain changes. For Class 8 tractor trailer combinations, mass can vary substantially, for example up to 50,000 lbs depending in part upon the type and amount of freight being hauled. Fuel usage variations due to a driver's driving habits can also be factored in when selecting a route. Alternative routes to a destination can then be compared and the route requiring the least amount of fuel can be selected.

In accordance with an embodiment, a method of determining and displaying a more fuel efficient vehicle route between two locations from a plurality of possible different routes is disclosed, the different routes being made up of links or route segments that begin and end with a node or link transition, each different route comprising at least one different link. The method can comprise:
(a) determining one or more energy values for links and nodes that define different routes between the two locations;
(b) storing the energy values associated with each link in association with the respective link and storing the energy values associated with each node in association with the respective node;
(c) summing the stored energy values associated with the links and nodes of plural different routes between the two locations to determine a total energy value for each of the plural different routes;
(d) selecting the route having the lowest total energy value; and
(e) displaying at least portions of the selected route to an operator of a vehicle, whereby the operator of the vehicle can follow the displayed route.

In accordance with another aspect, the act of determining the one or more energy values for links and nodes can comprise determining plural energy values at least for plural selected links that can vary, due for example in part to slope changes and traffic controls, with the direction along the link. In addition the act of determining can further comprise determining plural energy values at least for plural selected nodes that can vary, due for example in part to slope changes and traffic controls, based on the direction through the node. In addition, the act of storing can comprise storing respective plural energy values for each of the selected links in association with the selected link and storing respective plural energy values for each of the selected nodes in association with the selected node. Also, the act of summing can comprise summing stored energy values for links and nodes in the direction of a route along the link and through the node.

In accordance with another aspect alone or in combination with any one or more of the preceding aspects, the act of determining the one or more energy values for links and nodes can comprise determining plural energy values at least for selected links and plural energy values at least for selected nodes, the determined energy values for said selected links and selected nodes being based in part on an assumed vehicle mass, and the act of storing can comprise storing respective plural energy values based in part on assumed vehicle mass for each of the selected links in association with the selected link and storing the respective plural energy values based in part on assumed vehicle mass for each of the selected nodes in association with the selected node.

In accordance with another aspect alone or in combination with any one or more of the preceding aspects, the method can comprise determining the mass of a vehicle, and the act of summing can comprise summing energy values for links and nodes along a route that include the determined energy values for links and nodes along the route based in part on an assumed vehicle mass that corresponds to the determined vehicle mass.

In accordance with another aspect alone or in combination with any one or more of the preceding aspects, the method can be used in a system comprising categories of assumed vehicle masses, each category being a range of vehicle weights including one category ranging from the weight of an empty unloaded vehicle to a partially full vehicle of a second weight, another category ranging from a third weight to the weight of a vehicle at its maximum gross weighted load, and at least one category between said one and said another category, the assumed vehicle masses being a weight in each category (e.g. the weight at the middle of the category), and wherein the assumed vehicle mass corresponds to the determined vehicle mass when the determined vehicle mass is in the category of the assumed vehicle mass.

In accordance with another aspect alone or in combination with any one or more of the preceding aspects, the act of determining one or more energy values for links and nodes can comprise determining plural energy values for at least selected links and at least selected nodes based at least in part upon an assumed driving style.

In accordance with another aspect alone or in combination with any one or more of the preceding aspects, the method can comprise determining the driving style of a vehicle operator, and the act of summing can comprise summing energy values for links and nodes along a route that include the determined energy values for links and nodes along the route based in part on an assumed driving style that corresponds to the determined driving style.

In accordance with another aspect alone or in combination with any one or more of the preceding aspects, the method can be used in a system comprising categories of assumed driving styles comprising aggressive, moderate and defensive driving categories, wherein the act of determining the driving style comprises evaluating a driver and assigning a vehicle driver into one of the assumed driving styles with the assumed driving style into which the vehicle driver has been assigned thereby corresponding to the determined driving style.

In accordance with another aspect alone or in combination with any one or more of the preceding aspects, the act of summing can comprise summing the stored energy values associated with links and nodes and the selected driving style category of plural different routes between the two locations to determine a total energy value of each of the plural different routes for the driving style category.

In accordance with another aspect alone or in combination with any one or more of the preceding aspects, the act of determining one or more energy values for links and nodes can comprise determining plural energy values for at least selected links and at least selected nodes based in part on different traffic densities at different assumed times during a day.

In accordance with another aspect alone or in combination with any one or more of the preceding aspects, the act of storing can comprise storing respective plural energy values determined based in part on different traffic densities at different assumed times during a day for each of the selected links in association with the selected link. The method can also comprise storing respective plural energy values determined based in part on different traffic densities at different assumed times during a day for each of the selected nodes in association with the selected node.

In accordance with another aspect alone or in combination with any one or more of the preceding aspects, the method can be used in a system comprising plural categories of assumed traffic densities, such as comprising free flow, synchronized flow and congestion traffic densities. Energy values can be determined for each link for each applicable traffic density category and for each other assumed variable category (e.g., vehicle mass, driver style).

In accordance with another aspect alone or in combination with any one or more of the preceding aspects, the method can comprise determining the expected times that a vehicle traveling along a route will travel along a link or through a node. In addition, the act of summing can comprise summing energy values for links and nodes along a route that include the energy values for each link and node along the route determined based in part on a time during the day that corresponds to the expected time that a vehicle traveling along the route will travel along the link and through the node.

In accordance with another aspect alone or in combination with any one or more of the preceding aspects, the act of determining one or more energy values comprises determining a fueling force for each link and node utilizing a vehicle model, such as that can be expressed by the following formula:

F_{fuel}=F_{EngFriction}+F_{drag}+Fᵣₒₗₗ+F_{grade}+M_{vehicle}a+F_{Inertial}

,and converting the fueling force for each link and node to an energy value. In addition, as an alternative, the energy value can be expressed as a fuel quantity.

In accordance with another aspect alone or in combination with any one or more of the preceding aspects, the act of determining one or more energy values can comprise determining such values based in part upon an assumed mass of a vehicle and an assumed direction of vehicle travel along a link or through a node, energy values in a direction of travel along a link or through a node varying at least in part due to slope changes and traffic controls, decreasing in a direction that is downhill and increasing at a stop sign.

In accordance with another aspect alone or in combination with any one or more of the preceding aspects, the act of determining one or more energy values can comprise determining such values based upon the expected traffic density at an assumed time of travel along a link and through a node.

In accordance with another aspect alone or in combination with any one or more of the preceding aspects, the act of determining one or more energy values can comprise determining such values based upon an assumed driving style of a vehicle operator.

In accordance with another aspect alone or in combination with any one or more of the preceding aspects, the act of storing can comprise storing the determined the energy values in a relational map data base as attributes of links and nodes of such database, and wherein the act of summing the stored energy values associated with links and nodes of plural different routes between two locations comprises determining one or more of the mass of the vehicle, the road grade, the time a link is expected to be traversed or a node is expected to be traversed based on traffic density and speed limit, the direction of travel along a link or through a node and associated traffic controls, and the driving style of a vehicle operator, and extracting the stored energy values that correspond to these attributes for each link and node along a route and summing the extracted stored energy values for each of the plurality of routes.

In accordance with another aspect alone or in combination with any one or more of the preceding aspects, the act of determining energy values can comprise: (a) extracting the links and nodes and selected attributes of the extracted links and nodes for a plurality of routes between two locations from a relational map data base, (b) determining a vehicle speed profile for plural points along a first link included in the plurality of routes, (c) determining an energy value for the first link by simulating the vehicle performance along the first link, (d) determining a vehicle speed profile for travel through a first node included in the plurality for routes, (e) determining an energy value for the first node by simulating the vehicle performance through the first node, and (f) repeating steps (b) and (c) for all of the links included in the plurality of routes and repeating the steps (d) and (e) for all of the nodes included in the plurality of routes.

System components and the overall system configured for accomplishing the above method acts are also encompassed within the inventive aspects of this disclosure.

The invention includes all novel and non-obvious method acts and system elements and features disclosed herein both alone and in combinations and sub-combinations with one another. Also, method acts typically can be accomplished in various orders and still fall within the scope of this disclosure and claims. Non-transitory computer readable storage media, such as memory (not consisting of a signal) storing computer executable data and instructions for carrying out the embodiments disclosed herein are also included in the inventive features of this disclosure.

### BRIEF DESCRIPTION OF THE DRAWINGS

FIG. 1 is a schematic illustration of a number of possible routes between two locations A and B.

FIG. 2A is a schematic illustration of a portion of a route or link between two end points or nodes of the route portion.

FIG. 2B is a schematic illustration of another portion of a route or link, between two end points or nodes.

FIG. 2C is a schematic illustration of yet another portion of a route.

FIG. 2D is a schematic illustration of a further portion of a route.

FIG. 2E is a schematic illustration of a still further portion of a route.

FIG. 2F is a schematic illustration of another portion of a route.

FIG. 2G is a schematic illustration of still another portion of a route.

FIG. 2H is a schematic illustration of yet another portion of a route.

FIG. 2I is a schematic illustration of a further portion of a route.

FIG. 3 is a schematic illustration of forces acting on a vehicle traveling up an incline, in this example the vehicle being a truck.

FIG. 4 is a schematic illustration of an exemplary process for use in determining and storing energy values that can be associated with links and nodes of possible routes.

FIG. 5 is a diagram of exemplary vehicle speed profiles for a portion of a route wherein a vehicle is approaching an intersection at a node where the vehicle stops.

FIG. 6 is a schematic illustration of a vehicle speed profile for a vehicle approaching a node along a route where the vehicle slows down, such as due to a change in the posted speed limit.

FIG. 7 is a schematic illustration of a portion of a route having a node at which a vehicle accelerates; the schematic can be the same (but in a reverse direction) if the vehicle decelerates.

FIG. 8 is a flow chart of an exemplary procedure for assigning a driver's style category to a driver.

FIG. 9 is a flow chart of an exemplary approach for selecting a best route based on energy (and thereby fuel) consumption.

FIG. 10 is a schematic illustration of significant factors that impact fuel consumption along a route.

### DETAILED DESCRIPTION

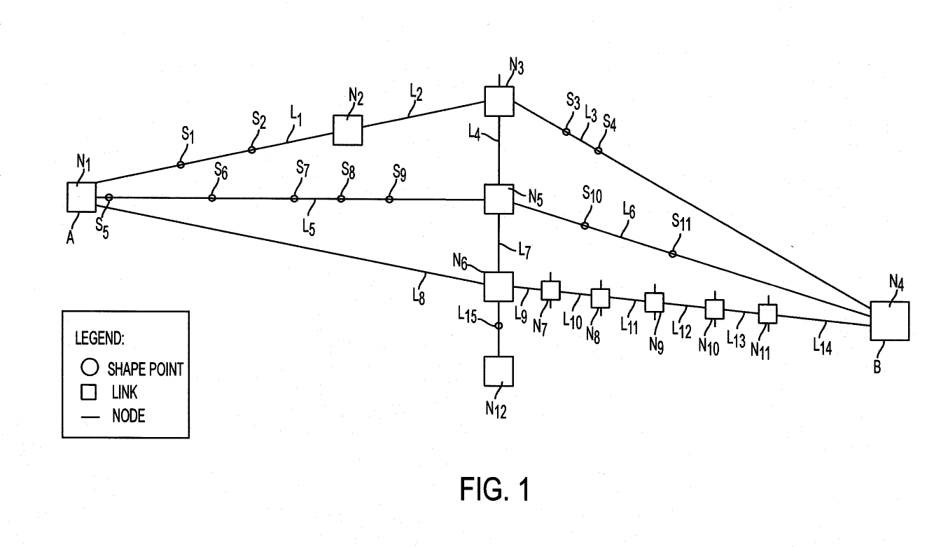

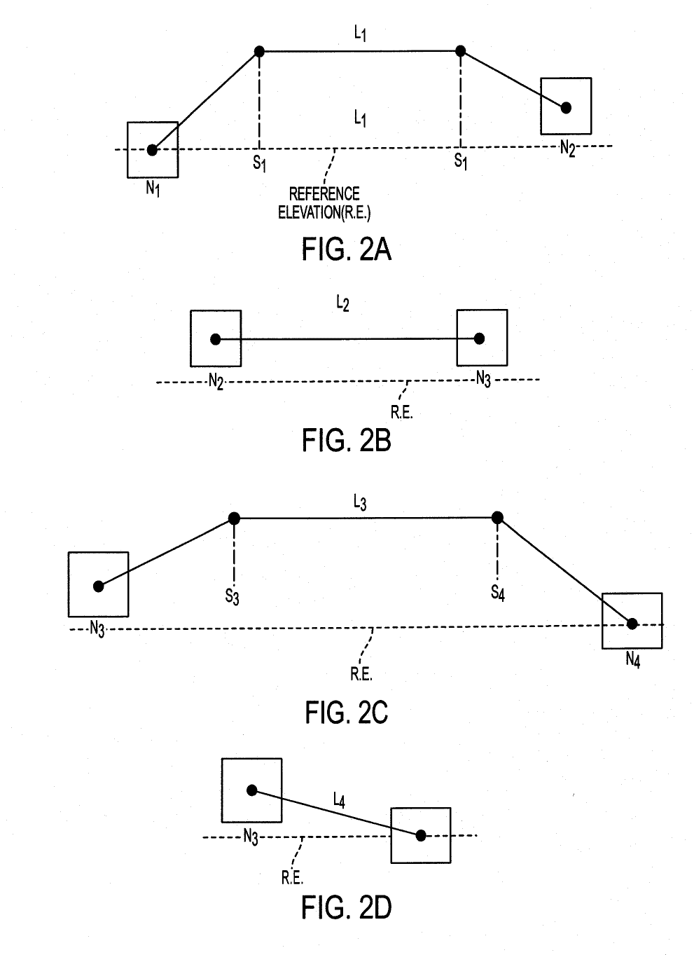

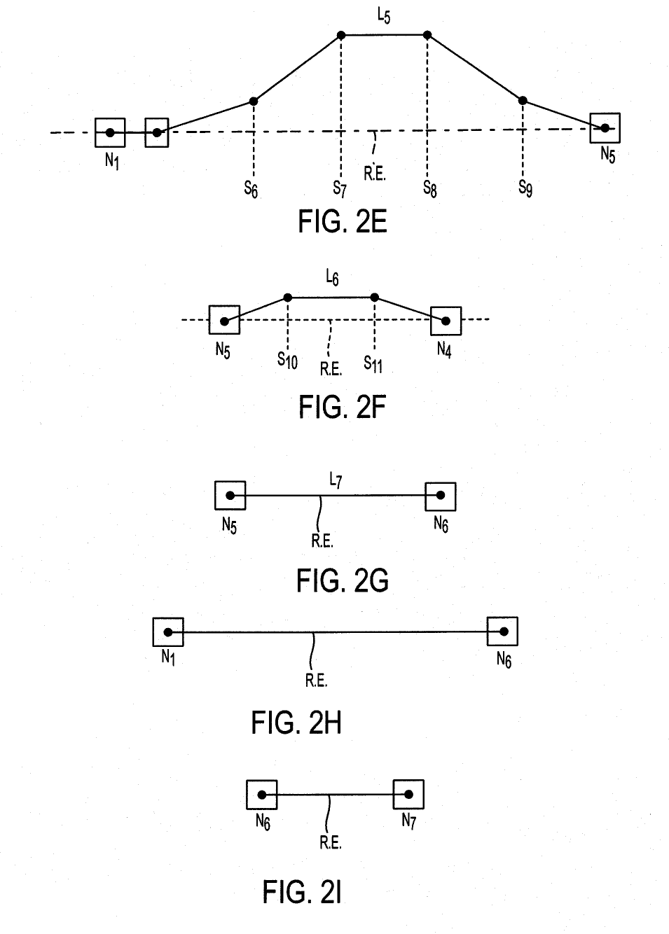

To provide an overview of the operation of an exemplary fuel efficient routing system and method in accordance with this disclosure, reference is made to FIGS. 1 and 2A through 2I.

In FIG. 1, two locations A and B are illustrated together with a plurality of potential near routes of travel along roadways between these two locations. The representation of the routes in FIG. 1 are made up of identified road segments or links such as L₁, L₂, . . . L₁₄. Each of the links is bound between nodes indicated by the letter N with a subscript. For example, L₁ is bounded between nodes N₁ and N₂. In FIG. 1, nodes N₁ through N₁₂ are indicated. These nodes correspond to transitions or potential transitions along a route such as locations where speed limits change, intersections exist, road characteristics such as bridges and/or tunnels are found, and where other potential speed or fuel usage impacting route features exist. In addition, a number of shape points are indicated on some of the links by the letter S together with a subscript. For example, shape points S₁ and S₂ are shown located on length 1 between nodes N₁ and N₂. Shape points indicate, for example, the beginning and end of road elevation changes and road curvatures. For a given link, there are often more shape points than shown in this simplified example of FIG. 1. The provision of road data in terms of links, nodes and shape points is a common approach. That is, road map databases that contain this data can be obtained from commercial digital map data providers. In addition, nodes, links and shape points are assigned attributes such as explained below, but these attributes are not known to include energy values or usage, which depend on functions such as vehicle mass, vehicle parameters and driving styles.

Referring again to FIG. 1, exemplary routes from location A to location B (with shape points not indicated in this list) are shown in Table 1 below:

TABLE I
Selected Routes From Location A to Location B

N₁, L₁, N₂, L₂, N₃, L₃, N₄
N₁, L₁, N₂, L₂, N₃, L₄, N₅, L₆, N₄
N₁, L₁, N₂, L₂, N₃, L₄, N₅, L₇, N₆, L₉, N₇, L₁₀, N₈, L₁₁,
N₉, L₁₂, N₁₀, L₁₃, N₁₁, L₁₄, N₄
N₁, L₅, N₅, L₄, N₃, L₃, N₄
N₁, L₅, N₅, L₆, N₄
N₁, L₅, N₅, L₇, N₆, L₉, N₇, L₁₀, N₈, L₁₁, N₉, L₁₂, N₁₀, L₁₃, N₁₁, L₁₄, N₄
N₁, L₈, N₆, L₇, N₅, L₄, N₃, L₃, N₄
N₁, L₈, N₆, L₇, N₅, L₆, N₄
N₁, L₈, N₆, L₉, N₇, L₁₀, N₈, L₁₁, N₉, L₁₂, N₁₀, L₁₃, N₁₁, L₁₄, N₄

For example, one route from location A to location B is from node N₁, along link L₁, to node N₂, along link L₂, to node N₃, along link L₃, and to node N₄. Node N₁ corresponds to a first location A in Table I and node N₄ corresponds to the second location B in Table I.

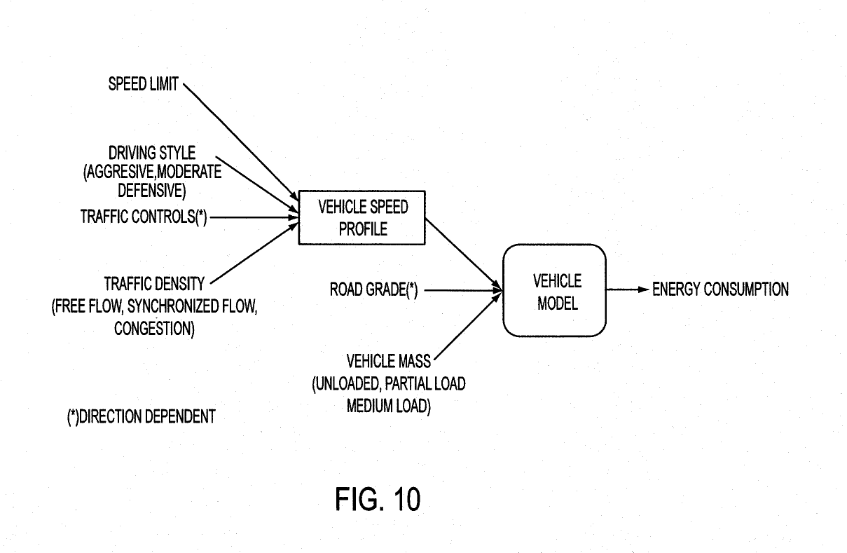

The start and end locations A and B, for example, can be entered by a vehicle operator into a vehicle navigation system (such as one from Garmin or Tom Tom), that has been modified in accordance with this disclosure. The start and end locations can otherwise be made available to the system. Any data entry device can be used, including remote entry devices such as wireless interfaces with the data being provided by, for example, a fleet dispatcher from a remote location. In addition, the system can start from the current vehicle position as the first location determined, for example, from a signal from a GPS signal source, or from another location-indicating signal source. A GPS receiver can be provided on a vehicle to receive the GPS signal. The route segments or links can be of equal length but are typically of differing lengths. For example, these lengths can be from 10 meters to thousands of meters. When a vehicle is traveling over flat terrain with little or no variation in vehicle operating conditions and long distances between node features, such as intersections, these segments can be extremely long. The length of the segments can also be varied depending upon other factors, such as beginning or ending at a node where the posted speed limit changes. Calculations of estimated energy values (which in one form comprises fuel usage or fuel usage calculations) can be made for each link in a possible route and stored as a value as an attribute associated with the respective link or node. Plural energy values can be stored in association with each link (such as values for different masses or categories of masses of vehicles, for different categories of driving styles, for different times of day where traffic density conditions change, for example, during rush hour). FIG. 10 is a schematic illustration of significant factors that affect energy consumption along links and through nodes of a route. Traffic density can be the number of vehicles (cars) per unit distance, or alternatively can be derived from bumper to bumper gap distance. The traffic density is also reflected in reductions in averages travel time per link based on time of travel (longer travel times imply higher densities).

When the energy consumption by an actual vehicle over a given possible route is being estimated, the energy value associated with each link that matches or corresponds to actual vehicle operating conditions [e.g., knowing the mass of the vehicle, the driver's style, the time for which the link will be traversed (and thus the density of traffic) and the direction of travel along the link], the appropriate energy value for the link corresponding to these vehicle operating conditions can be extracted from the database. The energy values for all of the links for a possible route can then be combined, such as by summing, to obtain a total energy value for the possible route. This can be repeated for other possible routes with a more fuel-efficient route then being selected as the route to be traveled by the vehicle. Energy values for nodes along a route can also be estimated and stored for various conditions. These node energy values can also be extracted when a route is being evaluated and combined with the extracted energy values for the links of the possible route to further refine the determination of expected energy usage associated with the possible route. Nodes where a vehicle does not stop can be ignored, if desired, because the adjoining links can capture energy values associated with changes in speed (acceleration and deceleration) when approaching and leaving such a node). Also, node energy values can be entirely ignored in some cases, such as for long haul freight trips where energy values for nodes can have a negligible impact on the total energy value for the route. The selected route can then be displayed, or portions thereof can be displayed (such as in the form of turn-by-turn directions or as a map via a display visible to the operator of the vehicle and/or also to a remote location such as a fleet dispatcher) for use in guiding the driving of the vehicle.

Computations of energy values can be performed by components located on the vehicle itself as well as remotely, such as in the cloud or at processors at a dispatcher's location or other remote location. The energy values can also be determined and indicated as equivalent distances, such as the distance the vehicle would travel operating at a given speed over a given distance on level conditions with the equivalent distances then being summed and the longest equivalent distance corresponding to the lowest energy consumption route.

A vehicle model can be used to determine the energy value attributes. For example, a fueling force can be computed using the energy model with the fueling force being multiplied by the distance along a link (for links being traversed) to determine an energy value attribute for the link that is associated with assumed vehicle operating conditions. Again, these stored values can then be summed or otherwise combined (the term “summed” encompasses combining the values in accordance with a function that is not limited to adding) to determine the total energy value for the route.

In addition, it is possible for a route that is identified based on energy efficiency to deviate from other criteria such that it would not be chosen. Thus, a comparison can be made of criteria in addition to the energy consumption with a selected route being one that exhibits good energy consumption characteristics even though it is not the least energy consuming route if the other criteria indicate that the selected route should be chosen. For example, the fastest route between two locations can be determined in a conventional manner in a criteria established that the least energy consuming route that is selected must be within a certain percentage of duration of the duration of the fastest route.

Referring to FIGS. 2A through 2I, examples of simplified links L₁, L₂, L₃ . . . L₁₄ and nodes N₁, N₂, N₃ . . . N₁₁ are discussed. More specifically, assume that link L₁ is along a freeway with a posted speed limit of 55. Also, assume that node N₁ is an exit ramp with no restrictions on straight through travel. Also assume that, if one were to exit from N₁ to either link L₅ or L₈, one would travel through a stop light. Other intersection information can also be provided, such as whether a right turn is permitted at the stop light N₁ without stopping before passing onto link L₈ with link L₅ being accessed by passing straight through the stop light. Thus, travel onto link L₅ could take longer on average, because the vehicle will stop longer on average, resulting in more fuel consumption because the vehicle is idling longer than a vehicle taking a right turn. Moreover, at certain times of the day, such as at rush hour (or other high density traffic times), the right turn on a red light may rarely happen, in which case the fuel consumption at the light would be the same whether traveling from N₁ onto link L₅ or onto link L₈. Assume also that node N₂ is a bridge that needs repair such that its posted weight limit is 30,000 lbs. (which would be exceeded by many fully loaded trucks). Also assume that shape points S₁ and S₂ are elevation transition points, the elevation profiles being illustrated in FIG. 2A. Also assume that the other shape points shown in FIGS. 2B through 2F also correspond to slope changes.

With reference to FIG. 2B, assume the speed limit along link L₂ is 55 miles per hour and that link L₂, like link L₁, is a freeway. Assume node N₃ is an overpass with an off ramp but that there are no restrictions on straight through traffic. Also assume if one exits at node N₃ to link L₄, one passes through a stop light with a right turn on red permitted.

With reference to FIG. 2C, assume that the posted speed limit on link L₃ is 55 miles per hour. However, assume that during the hours of 6 to 9 a.m. and 3 to 7 p.m. there is heavy traffic congestion so that the average speed along the link is reduced to 30% of the posted speed (to 16.5 miles per hour during such hours). Traffic congestion (density) information based on time of the week (at one hour increments), is known to be provided in relational map databases. This data can be converted to categories of traffic density used in energy value calculations. For example, the traffic density categories can be: free flowing (no congestion) so that the average speed along the link is assumed, for example, to be the posted speed along link; 90% of the posted speed; 60% of the posted speed; and 30% of the posted speed.

With reference to FIG. 2D, assume for link L₄ the speed limit is 35 miles per hour (e.g., an urban cross street). Also assume that node N₅ corresponds to an intersection that passes unrestricted straight through from link L₅ to link L₆. Also assume that the intersection at node N₅ has a stop sign from both of the L₄ and L₇ link directions. In addition, assume that an additional attribute is associated with link L₄ that, if met, would block a vehicle that meets the attribute [e.g., no hazardous waste, no vehicles over a certain weight, a height restriction, a vehicle type restriction (e.g., a no truck zone), the road type is below a certain class along which it is undesired for the vehicle to travel (e.g., the road is in an unpaved road class), or there is a road closure].

Referring to FIG. 2E, assume that along link L₅ the posted speed limit is 55 miles per hour, that it is a county road (there would be more curves than actually shown and thus more shape points, as only shape points with elevation changes S₅ through S₉ are shown). Referring to FIG. 2F, assume the posted speed limit for link L₆ is 55 miles per hour except between 6 and 9 a.m. and 3 and 7 p.m. where there is a 60% speed reduction due to traffic congestion (e.g., a reduction to 33 miles per hour). In addition, with reference to FIG. 2G, for link L₇, assume the speed limit is posted at 35 miles per hour and that it is a four lane city street. Assume that node N₆ indicates an intersection controlled by a stop light in both direction with signal controlled left turn lanes. With reference to FIG. 2H, assume link L₈ is a county road with a posted speed limit of 45 miles per hour.

With reference to FIG. 2I, assume that links L₉ through L₁₄ are all the same (apart from distance), with a speed limit of 45 miles per hour on each link, the links corresponding to a county road, and that each of the nodes N₇ through N₁₁ are intersections controlled by a stop light in both directions with no left turn lanes.

With the above assumed conditions for links and nodes, it is apparent that different fuel usage and energy values will be associated with the different links and nodes depending upon factors such as the mass of the truck, the traffic density correlated with the time of day, the driver's style, the direction of travel and vehicle parameters. For example, a route utilizing link L₄ could not be used by a vehicle carrying hazardous waste. A route containing node N₂ could not be used by a vehicle heavier than 30,000 lbs. A route including link L₅, because of the hill on link L₅, would require more fuel when traveled by a heavier loaded truck than by a lighter truck. A route including links L₉ through L₁₄ and nodes N₇ through N₁₁ would require numerous accelerations and decelerations, thus using more fuel when traveled by an aggressive driver.

In a conventional relational map database, links are bounded by a node, that is, they start and end at a node. A route can be defined as a series of nodes and links that connect a vehicle's current position to a specified destination or that connect a starting location to an ending location.

Attributes that have been assigned to a link include the length (distance), direction of travel, road class (e.g., interstate, limited access highway, state route, city street, county road, forest road, etc.); travel time to traverse a link at the road speed limit; road speed limit; road weight limit; traffic congestion or density indicated by average speed per link based on the hour of the week (168 hours/week), curvature [1/R where R is the radius of curvature].

Attributes that have been assigned to nodes include intersection information attributes, such as stoplight control, stop sign control, right turn without stopping, signal phase (e.g., how long a light is red, yellow and green in a particular direction), turn restrictions (e.g., whether right turn allowed without stopping, whether right turn permitted on red light, whether left turn permitted), nature of node (such as railroad crossing, ferry crossing, bridge), elevation/slope, grade (direction dependent), and probability values associated with waiting at an intersection (10% or less that one will wait for a left turn for more than 30 seconds).

Shape points are known to consist of coordinates along a link that give the link its shape in terms of curvature or elevation profiles. Attributes that have been assigned to shape points include elevation, grade (slope), distance from start node, and curvature (1 over R where R is the radius of curvature).

In accordance with this disclosure, link exclusions can also be added as attributes to links and nodes. Examples of exclusion attributes can comprise attributes indicating no hazardous material (e.g., a tunnel or bridge where travel carrying such material is prohibited), road below a certain class along which a type of vehicle is not to travel, allowed weight limit, height restrictions, road closure to a particular type of vehicle, total load closure, construction delays in excess of a specified time.

In accordance with this disclosure, energy values can be computed and stored as attributes of links and nodes by simulation utilizing a vehicle model. In one desirable example, the following components can be used to determine fuel or energy required for a vehicle to travel along a given route. The first of these components or inputs is a description of internal and external forces that encompass vehicle factors. A second component includes inputs in the form of route factors that can consist or comprise information contained in a digital map database. The third optional component entails driver factors which can account for changes in energy usage due to driving styles and their influence on fuel consumption.

### Vehicle Factors

A vehicle model consisting of longitudinal forces can be used as a basis for determining fuel requirements due to vehicle factors. This model describes a force F_{vehicle} required by the vehicle to overcome opposing forces to maintain a constant vehicle speed, accelerate or decelerate. One expression of the model is found in the following equation:

F_{fuel}=F_{EngFriction}+F_{drag}+Fᵣₒₗₗ+F_{grade}+M_{vehicle}a+F_{Inertial}

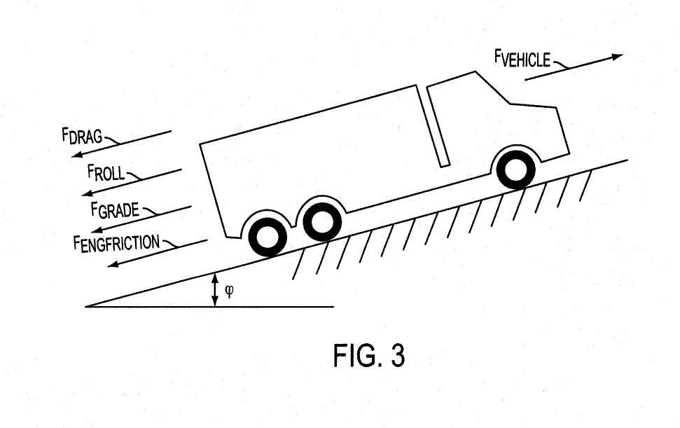

The following forces that act on the vehicle are schematically represented in FIG. 3 and are described in more detail below.

$$Propelling Forces$$

$$Fueling Force \text{:} \qquad {F}_{fuel} η k {τ}_{request}$$

$$External Opposing Forces$$

$$\begin{matrix}Drag Forces \text{:} & {F}_{drag} = \frac{1}{2} ρ {A}_{f} {{c}_{d} ( {v}_{link} \pm {V}_{wind} )}^{2} \\ Rolling Forces \text{:} & {F}_{roll} = {M}_{veh} {gC}_{rr} cos {ϕ}_{link} \\ Grade Forces \text{:} & {F}_{grade} = {M}_{veh} g sin {ϕ}_{link}\end{matrix}$$

$$Internal Opposing Forces$$

$$\begin{matrix}Engine Friction Torque \text{:} & {F}_{EngFriction} = η k {τ}_{EngFriction} = η k f ( ω ) \\ Inertial Forces \text{:} & {F}_{inertial} = η {J}_{eng} {k}^{2} a + \frac{{J}_{eng}}{{r}_{wheels}^{2}} a\end{matrix}$$

The calculation of propelling and opposing forces utilizes a knowledge of vehicle parameters, such as explained in the example below. More or fewer parameters can be used.

### Vehicle Parameters

c_{d} Coefficient of drag is a static parameter is based on the aerodynamic characteristics of the vehicle and can be empirically determined for each vehicle type through testing in a known manner. The coefficient of drag for many vehicles, such as heavy duty trucks, is also available from the manufacturer of the vehicles.
A_{f} Frontal area of the vehicle is a static parameter is based on the frontal geometry of the vehicle. One example is to determine the area of the portion of a vertical plane occupied by a projection of the vehicle onto the plane. Certain components (e.g., bumpers and wheels) can be excluded, if desired. The frontal area of a vehicle can be calculated using a CAD system, or provided by a vehicle manufacturer.
Cᵣᵣ Coefficient of rolling resistance is a parameter that is proportionately related to vehicle speed. A lookup table, for example, can be used to establish the value for this parameter. Alternatively, this can be assumed to be constant, such as the value for dry pavement.
Mᵥₑₕ Vehicle mass is a parameter that varies based on the load being hauled (e.g., load free weight of the truck plus the weight of the load). The vehicle mass can, for example, be estimated using existing mass estimation algorithms. Alternatively it can be entered by the driver based on knowledge of the mass or pre-defined mass categories (e.g. empty, partially loaded, fully loaded).
τ_{EngFric} Friction torque is a parameter which is a function of engine speed (ω). A lookup table for specific engine models can be used to establish the appropriate friction torque for a given speed. Friction torque is available from vehicle engine manufacturers, but can be determined empirically by measuring the engine's friction at various speeds using a dynamometer.
τ_{request} The requested torque value is an input from either the accelerator pedal position or from another source such as a cruise controller in the engine control module. A fuel map can be used in a conventional manner to calculate the amount of fuel consumed based on the requested torque and current engine speed.
η Driveline efficiency. A factor that is available from a vehicle manufacturer.
k Ratio of engine speed over vehicle speed, which factors in the transmission gear ratio, rear axle gear ratio and the wheel radius, such that:

$$k = \frac{EngineSpeed}{VehicleSpeed} = \frac{{n}_{drive} {n}_{transmission}}{{r}_{wheel}}$$

The k value varies as the vehicle transmission shift gears, which consequently affect the frictional, inertial forces acting on the vehicle as well as fuelling. Therefore a transmission shift logic that determines optimal shift points and upshift and downshift timing should be incorporated in the vehicle model.
J_{eng} Moment of inertia for the vehicle engine.
J_{wheels} Moment of inertia for all of the vehicle wheels (e.g., 18 wheels for some trucks).
r_{wheels} Radius of the wheels.
   Global Parameters (that can be assumed to be constant)
ρ Density of air.
g Gravitational constant.
V_{wind} Wind velocity (e.g., can be assumed to be zero.).

Additional information concerning these vehicle parameters and how they can be obtained and used is disclosed in U.S. patent application Ser. No. 12/197,064 entitled VEHICLE DISTURBANCE ESTIMATOR AND METHOD that was published on Feb. 25, 2010, as U.S. Published Application No. US-2010/0049400 A1, and which is incorporated by reference in its entirety herein.

Route factors used in the above calculations can be obtained or extracted from a relational map database. These route factors include route parameters which can comprise the route parameters set forth below.

### Route Parameters

νₗᵢₙₖ Road speed limit of link or sub-link. This parameter can be provided by a map database.
φₗᵢₙₖ Road grade of link or sub-link. This parameter can be provided by the map database
dₗᵢₙₖ Distance of link or sub-link. This parameter can be provided by the map database.
ρₗᵢₙₖ Traffic Density of link or sub-link. This parameter can be provided by (or derived from) the map database.
t_{node} The time spent at a node. This parameter can be estimated for specific node types (e.g. containing traffic control information such as a stop sign or stop light).

As described earlier, it is possible to calculate an estimate of energy required for a given link and node (and thereby an estimate of fuel consumption for the given link or node using the vehicle model). The fuel value can be stored in the map data as an additional attribute to be used for routing purposes. The routing algorithm can use the fuel values as a basis to determine the most appropriate route by minimizing the required fuel to reach a specified destination.

### Driver Factors

Additional factors that influence fuel consumption include those that are dependent upon driving style. In particular, vehicle acceleration and deceleration depend on the driver, in terms of how aggressive or passive the driver typically behaves. An aggressive driving style is characterized by greater magnitudes of acceleration and deceleration, which is less fuel efficient and would incur a relatively large fuel penalty for each acceleration or deceleration event. Conversely, a passive or defensive driving style would be characterized by a driver that would typically accelerate and decelerate more slowly, thereby incurring a relatively small fuel penalty for each event. A moderate driving style driver would be one that would typically accelerate and decelerate at an intermediate rate. A driver profile or style can optionally be taken into account to determine the fuel consumed or energy value for each road link that have vehicle speed limit changes or traffic controls that require acceleration or deceleration. The driver profile or style can be determined, for example, by tracking a driver's performance (e.g., rate of accelerations and decelerations and/or torque requests, at stop signs, speed changes, etc.) over time. Alternatively, a driver, vehicle owner, or fleet manager can designate a driver profile from a plurality of such profiles, such as predetermined aggressive, moderate and conservative or defensive driver profiles.

As a specific example, the driving style of a vehicle operator can be categorized, such as aggressive, moderate or defensive. For example, for a given mass of a vehicle, or ranges of mass, a predetermined number of accelerations and decelerations can be monitored (such as to or from a dead stop, or to and from one vehicle speed to another vehicle speed). For example, for one vehicle mass, a driver can be categorized as having a defensive driving style if the average rate of acceleration or deceleration is up to 0.2 m/sec² over a predetermined number of measurements, such as ten measurements; categorized as a moderate style driver if the average acceleration and deceleration rates is between 0.2 m/sec² and 0.4 m/sec²; and categorized as an aggressive driving style if the average acceleration and deceleration rates is 0.4 m/sec² or higher. These categories can be determined in other ways and more or fewer than three categories can be used. As another alternative, requested torque can be monitored during accelerations (by monitoring throttle position) with driver styles being assigned, for example, where averages of torque requests fall in a torque request range corresponding to a specific driver style category.

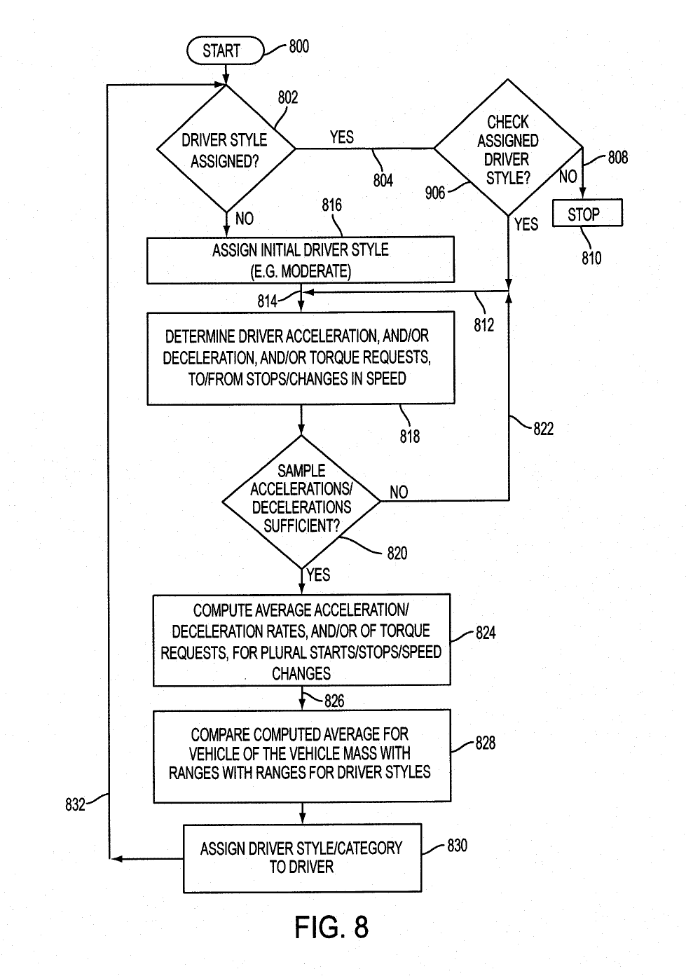

As a specific example, and with reference to FIG. 8, an exemplary approach for assigning a driver a driver style category is illustrated. The example starts at block 800. At block 802 the question is asked whether the driver style has been assigned. If the answer is yes, a branch 804 is followed to a block 806 where it is asked whether it is desired to check the assigned driver style to see if another driver style should be assigned. If the answer is no, a line 808 is followed and the procedure stops at 810 until the next time it is started at block 800 (such as when the vehicle ignition is turned on). If the answer at block 806 is yes, a line 812 is followed to rejoin the procedure at a line 814. If in contrast, at block 802 a determination is made that the driver style has not been assigned, a block 816 is reached, at which block the driver is optionally assigned an initial driving style as moderate. From block 816, the branch 814 is followed to a block 818 at which measurements are made of driver accelerations and/or decelerations or driver torque requests (either accelerations can be measured, decelerations can be measured, or both can be measured) to and from vehicle stops or in connection with changes in vehicle speed. From block 818, a block 820 is reached at which a determination is made whether enough samples have been obtained. If the answer is no, branch 822 is followed back to line 812, to line 814 and to block 818 at which measurements continue. If the answer is yes at block 820, a block 824 is reached at which a driver style evaluation function is applied to the data, for example, a computation is made of the average acceleration and/or deceleration rates for plural stops and/or speed changes or of an average of torque requests for acceleration. From block 824, a branch 826 is followed to a block 828 at which a comparison is made of the average acceleration/deceleration value for the vehicle mass with ranges for driver styles. From block 828, a block 830 is reached and the driver's style is assigned. From block 830, the process returns to block 802. Again, the approach is not limited to averaging acceleration and/or deceleration measurements or torque requests for acceleration as other methods of combining measurements can be used.

Knowing the driver's style, a driver parameter can be defined such as follows.

### Driver Parameter

aₗᵢₙₖ The average acceleration or deceleration values expected by the driver, such as from a driver profile or from tracking the driver's behavior on that day or over another time period.

Given the driver's profile and or driving style and the anticipated (e.g., average) acceleration or deceleration values expected by the driver having the assigned driving style, the impact on energy (and fuel) usage by the driver over a link and/or through a node can be factored into the energy usage computation for the link and/or for a node. For example, assume at a node the speed limit changes from 45 to 55 and that there are no other changes, the energy value stored in association with the link approaching the node and the link leaving the node can be based in part on the driving style. For example, the energy value for a vehicle that accelerates to a new speed limit with an aggressive driver would be higher than the energy value for the value for a defensive driver.

As will be more apparent from the description below, given the route and vehicle information [including various assumed vehicle mass categories (for example, five such categories or three such categories], and if used variations dependent upon the driving style energy usage values for each of the assumed conditions can be determined and associated as attributes of the respective links and nodes. Time dependent (traffic density impacted) energy values can also be determined. For example, an energy value can be determined for each traffic density category (e.g., three traffic density categories, with more or less categories being possible), for each vehicle mass category (e.g., three or five vehicle mass categories) and for each driver style category (e.g., three driver style categories, with more or fewer categories being possible). The energy value for each of these respective combinations of conditions can be stored, for example as an attribute, of each link and each node in a relational map database. Then, when alternative routes are being evaluated, the energy value for each link that matches the conditions of an actual vehicle, driver style and traffic density experienced by a vehicle traveling along the route can then be extracted and combined to provide a total energy value for each of the alternative routes. The Dijkstra Algorithm is an example of an approach that can be used to select the routes to be evaluated and to select the best route from an energy usage standpoint. It is not necessary for an energy value to be associated with each link or node as, for example, some nodes can be ignored (such as nodes where a vehicle does not stop because, for example in this case, deceleration and acceleration energy changes can be captured in adjacent links approaching and leaving the node). Also, placeholder energy values, such as zero, can be assigned to selected nodes or links that are to be ignored.

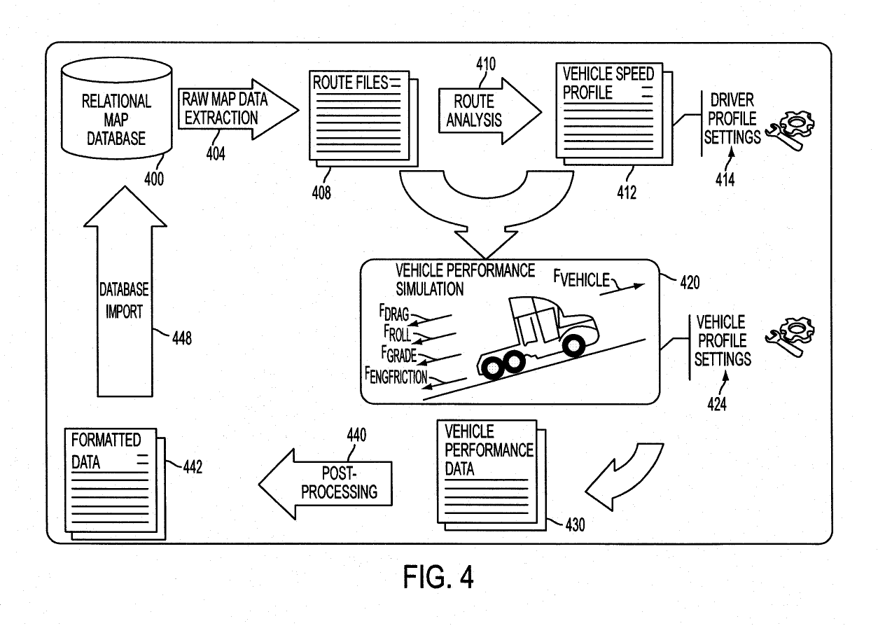

With reference to FIG. 4, a relational map database 400 is shown with data stored therein with links and nodes that are to be used in the simulation to determine an energy value for various vehicle mass, traffic density and driver style category conditions. At 404, raw map data (attributes for links and nodes) needed for a simulation; (e.g., distance, direction, road grade, speed limit, intersection information, traffic density information) are extracted and at 408 various alternative routes between locations A and B are assembled, with each route typically consisting of a connected string of nodes and links between the locations. The route files can be constructed from near alternative routes rather than from all routes between two locations. For example, in traveling from Portland, Oreg. to Seattle, Wash., near alternative routes would not include a route through Spokane, Wash. and back to Seattle. Constructing route files for near alternative routes is conventional. The near alternative routes are then analyzed to provide, in this example, a vehicle speed profile for the overall route.

Alternatively, the vehicle's speed profile can comprise a vehicle reference acceleration profile due to the relationship between speed and velocity. A vehicle speed profile can be adjusted based on alternative driver styles or profile settings (e.g., aggressive, moderate or defensive driving styles), traffic controls and traffic density information, to provide a modified vehicle speed profile or modified reference acceleration profile. The vehicle speed profile over a link can be an estimated vehicle speed at periodic points along a link. The speed profile can be constant over links that do not change (e.g., flat, constant speed limit). The respective route files and vehicle speed profiles can be provided as inputs to a vehicle performance simulator at 420 that performs a vehicle performance simulation. Simulator 420 utilizes the route file information and the vehicle speed profile information together with vehicle parameter inputs from vehicle profile settings 424 in performing the simulation. If data is missing (for example, data for a particular node is incomplete or missing), an assumption can be made to allow the simulation to continue. For example, if a node comprises an intersection and it is not known whether a right turn is permitted at the intersection, an assumption can be made that a right turn is not permitted. If data is so incomplete that a meaningful performance simulation cannot be obtained, the simulation of a link can be bypassed. Vehicle performance simulator 420 can comprise any suitable processor such as a programmed computer and suitable memory, an onboard vehicle processor, computations performed in the cloud, and/or a processor located at a remote location such as at a fleet dispatch or headquarters location. Any suitable processor can be used to perform the vehicle simulation. Vehicle performance data, indicated at 430 (for example, energy consumption on a per link and per node basis), is provided as an output from the vehicle performance simulator and comprises or consists of energy values (that represent fuel consumption) under a specific set of conditions for a particular associated link or node. This data can then be processed at 440 to provide formatted data 442 (e.g., rounded to integer values) in a form suitable for inputting via a data input device 448 into the relational map database such that the energy values can be stored in association with the respective associated links or nodes, such as attributes of the associated link or node.

### Map Data Processing

This section further describes an exemplary process of generating energy (fuel) consumption data for all links that form the map database. Desirably all of the links that potentially impact energy consumption are included. The energy (fuel) consumption data attributed to the links forms the basis for optimized routing and determining the most fuel efficient route. All or selected nodes can also be included, such as selecting nodes where the nodes impact fuel consumption (e.g. a land vehicle idles at an intersection represented by the node).

An exemplary overall process consists of three main steps, which are highlighted below. The first step, route definition, entails the extractions of specific routes and attributes from the map database. The extracted data is analyzed and can be pre-processed (e.g., for proper formatting) for use in a vehicle simulation.

The second step, vehicle performance simulation, desirably involves calculating the vehicle performance over a route, in terms of energy (fuel) consumed, and based on the specific vehicle configuration.

As a final step in this example, post-processing, desirably entails the converting of the resultant energy (fuel) consumption representing data into a format that can be re-imported into the map database.

### Route Definition

Raw map data extraction: In this step, data is queried from a map database for a specific route to be simulated. This query retrieves the relevant link geometry data and associated attributes of that route. The individual links, shapepoints and nodes are arranged in order to form a contiguous virtual stretch of highway. The result of this query and arrangement is a route file, that can contain, comprise or consist of the following attributes:

| Attribute Name | Description |
|---|---|
| Longitude | signed, decimal notation, e.g., to seven decimal places (negative |
| | value can be = western hemisphere, positive value can be = |
| | eastern hemisphere) |
| Latitude | signed, decimal notation, e.g., to seven decimal places (negative |
| | value can be = southern hemisphere, positive value can be = northern |
| | hemisphere) |
| Heading | decimal notation, e.g., to one decimal place (e.g., 0 = north, |
| | 90 = east, 180 = south, 270 = west) |
| Position | Decimal notation e.g., to one decimal place, expressed, for |
| | example, in meters from the starting point of the route file. |
| Grade | Signed, percentage value, e.g., to two decimal places that |
| | indicate grade based on the direction of travel. (positive value |
| | can be = uphill, negative value can be = downhill) |
| Speed Limit | e.g., integer notation in miles per hour |
| Functional Class | e.g., integer notation, {1 to 7} [road class] |
| Road Name | e.g., Multi-character (e.g. US-101) |
| Road Direction | e.g., Single character {N, S, E, W} |
| State/Province/ | e.g., Two character (e.g. OR for Oregon) |
| Territory | |
| Traffic Controls | e.g., Two character (e.g., SL = stop light; LT = left turn). |
| Traffic Density | e.g., Two character (e.g. FF = free flow, CG = congestion) |

Route Analysis: This step applies driver profile settings to the route file to determine the reference vehicle velocity for that route. The vehicle speed limits and expected acceleration/deceleration values that describe the driver profile and traffic density can be applied with the route use cases described above to derive a vehicle speed profile for the vehicle simulation.

### Vehicle Performance Simulation

This step uses the route file and vehicle speed profile to simulate the vehicle's performance (in terms of fuel consumption) as it travels across the route. The simulation, in this one embodiment, is based on the longitudinal vehicle dynamics model described earlier along with the vehicle profile settings that describe the vehicle-specific characteristics. The simulation generates a profile describing fuel consumption and actual travel time.

### Post-Processing

This step processes the fuel consumption and travel time profiles generated by the simulation in a format that can be imported into the relational map database. Firstly the profiles can be parsed into segments which correlate to the link geometry. The parsed profile data can be associated with each link using attributes and can be imported into the relational map database such as additional tables with indexes to their respective links.

### Exemplary Alternatives

Alternatively, the fuel consumption profiles (one form on an energy value expression) can be used to calculate values which can more readily be used for existing route optimization algorithms with little or no modification. The following additional variables, namely “equivalent distance” and “weight factor”, can be calculated and also inserted into the relational map database.

### Equivalent Distance

This value represents a modified distance for each associated link based on the fuel influences imposed on the vehicle such as due to terrain, vehicle speed changes, and other factors, if desired. The modified distance value essentially takes fuel factors into account and can be used in route optimization calculations in lieu of the actual link distance. The equivalent distance can be defined as the distance the vehicle could travel, given actual fuel and/or energy consumed, during a route that has no terrain or vehicle speed changes.

### Weight Factor

This value can be used in some route optimization calculations as a mechanism to either incentivize or de-incentivize the use of a given link. Weight factors can be derived from the fuel consumption profile to be used as a means to encourage or discourage the use of specific routes based on the fuel consumed.

For example, one type of a vehicle traveling on a specific 5-mile link with a specific uphill grade consumes 1 gallon of fuel. Assume under normal circumstances that this type of a vehicle can travel 6.5 miles on a flat road with 1 gallon of fuel. Therefore, the “equivalent distance” for the 5 mile link is 6.5 miles. The weight factor would be 6.5/5.0=1.3. Both values indicate the undesirability of the specific link since a relatively large amount of fuel is needed to travel the link.

The above determinations can be made whether a cruise control is active or inactive. The driver profile can become a non-factor for segments when the cruise control is active (or expected to be active based on, for example, a probability function).

### Fuel or Energy Simulation Calculation Examples Under Selected Conditions

Fuel is consumed in various modes when the vehicle is in motion and at stand still (e.g., when idling). Described below are examples of how energy values (that can be expressed as or represent fuel consumption) can be calculated in each of these modes.

(I) Fuel consumed traveling at constant speed: Once F_{vehicle} has been defined the fuel or energy required to move the vehicle at a constant speed along a link can be determined (e.g. estimated) by multiplying distance:

E_{speed}=F_{vehicle}dₗᵢₙₖ

This equation is typically used as long as the map-specific parameters νₗᵢₙₖ,φₗᵢₙₖ and dₗᵢₙₖ remain constant across the entire length of the link. If for example a road grade change occurs within a link, the link can be further broken into separate sub-links (bounded by nodes or shape points) containing constant parameter values in order to facilitate the calculation of the required energy values or fuel usage. This energy value can be stored in the map database as an attribute for a given link for the conditions of the calculations and used later for a fuel usage or total energy value calculation for a route (route calculation).

(II) Fuel consumed at Standstill: In addition to attributing fuel values for specified links, it is also desirable, but not required, to account for the required fuel at nodes. Nodes are geometrical relations between multiple links and can represent either a number of links in series, or intersections.

At intersections, fuel is consumed to maintain engine idling while the vehicle is not in motion. The fuel consumed while idling at an intersection depends on factors such as the engine idle speed, friction torque and time spent at the node. While the vehicle is at a standstill, mass would not be a factor. One exemplary calculation is as follows:

$${E}_{node} = {\int }_{{θ}_{1}}^{{θ}_{2}} τ ( ω ) d θ$$

Where τ(ω) is the engine friction torque at idle speed and θ₁_{^{—}}θ₂ is the number of crankshaft revolutions that occur during time spent at the node.

(III) Fuel consumed during Acceleration and Deceleration: a vehicle will accelerate and decelerate at different locations along a given route, which in turn affects the required fuel. For example a vehicle can launch from a standstill at a node to typically reach a substantially constant vehicle speed and can reduce speed when approaching a node. Changes in the vehicle speed limit along a route will also result in accelerations or decelerations to the new speed limit. Varying fuel rates (energy values) are needed to overcome inertial forces to accelerate or decelerate the mass of the combined vehicle, such that:

E_{accel/decel}=(Fᵢₙₑᵣₜᵢₐₗ+m_{vehicle}a)dₗᵢₙₖ

The variable a represents the vehicle's acceleration as a positive value or the vehicle's deceleration as a negative value. As mentioned previously, the acceleration and deceleration values used in the calculation can depend on the selected driver profile or driver style category, if employed. Alternatively, an assumption can be made about the driving style (e.g., that the driver has a moderate driving style).

With this equation it is possible to determine the fuel required at a given node.

The total fuel required for a route under the conditions of the simulation (e.g., vehicle mass, time of day (which captures traffic density changes) when traversing the link or traveling through the node, driving style) would be the sum of the fuel required for all links and nodes that make up the route, such that:

Eₜₒₜₐₗ=ΣE_{speed}+ΣE_{node}+ΣE_{accel/decel}

### Route Use Cases

The vehicle will encounter numerous different combinations of intersections, which influence the vehicle velocity or vehicle speed profile across the route and in turn, how much fuel is consumed. For each combination of intersection features such as traffic controls and conditions of the simulation, a vehicle velocity profile and driving behavior is desirably defined. This section describes various use cases and their associated velocity and driver profiles, which can be used to calculate energy values (corresponding to fuel usage).

### Vehicle Speed Profiles

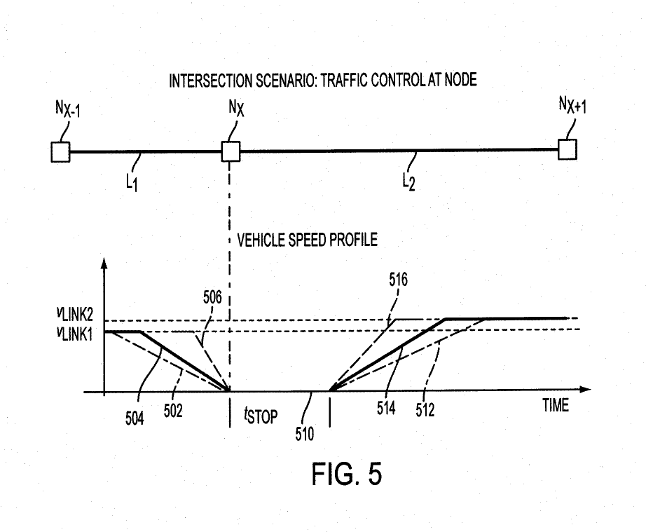

I) Vehicle Stop Scenario (see FIG. 5)—occurs at intersections with a stop sign, traffic signal (e.g. red light) and permitted turns where stopping is required. Deceleration, stopping and acceleration steps are represented in FIG. 5.

| | |
|---|---|
| a) In FIG. 5, a vehicle decelerates when approaching | v_{vehicle} = vₗᵢₙₖ₁ . . . 0 |
| the traffic control at node Nₓ from the posted speed | |
| limit (vₗᵢₙₖ₁) to standstill, while traveling on | |
| preceding link (L₁). Straight line (constant) | |
| deceleration is assumed, deceleration can be a | |
| function other than a constant rate, (e.g., a decaying | |
| exponential curve). | |
| Deceleration from lines 502, 504 and 506 | |
| correspond to defensive, moderate, and | |
| aggressive driving styles. | |
| b) The vehicle remains idle for a period of time | v_{vehicle} = 0, |
| (tₛₜₒₚ) indicated by number 510 in FIG. 5. | for time t_{Stop} |
| c) The vehicle launches from standstill and | v_{vehicle} = 0 . . . vₗᵢₙₖ₂ |
| accelerates to a posted speed limit (vₗᵢₙₖ₂) along the | |
| succeeding link (L₂). Again, constant acceleration | |
| is shown (in this case for defensive, moderate and | |
| aggressive driving styles at 512, 514 and 516), but | |
| acceleration can be described by a function other | |
| than a constant rate. | |

In this example νₗᵢₙₖ₂ may be greater than, less than or equal to νₗᵢₙₖ₁ depending on the characteristics of each intersection. The time spent waiting at the intersection, tₛₜₒₚ, can be intersection dependent. However the actual time will vary each instance the vehicle approaches the intersection. The time variations and one exemplary approach for addressing these variations in the route calculation are discussed below.

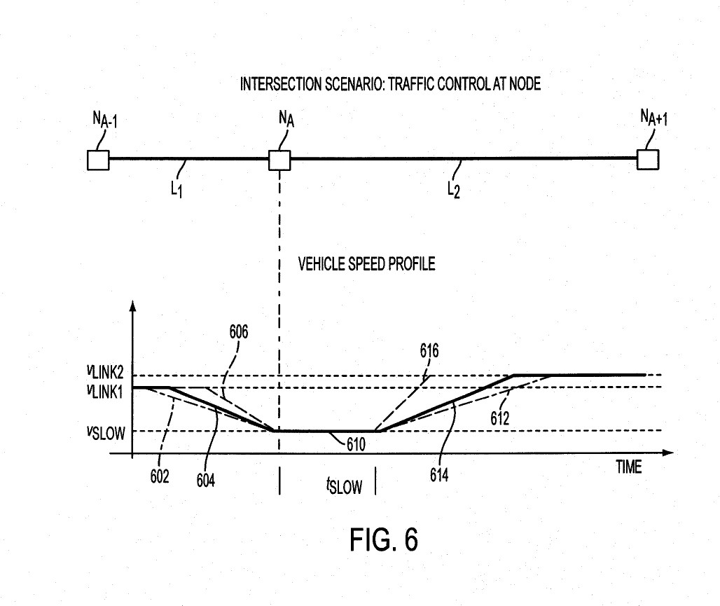

II) Vehicle Slowdown Scenario (see FIG. 6)—occurs at intersections with yield signs, traffic signal (e.g. green light), protected turns and traffic circles (e.g., roundabouts) where stopping isn't required. Deceleration, slow down and acceleration stops are shown in FIG. 6.

| a) In FIG. 6, a vehicle decelerates when | v_{vehicle} = vₗᵢₙₖ₁ . . . v_{slow} |
|---|---|
| approaching the traffic control at node N_{A} | |
| from the posted speed limit vₗᵢₙₖ₁ to a slower | |
| speed v_{slow}, while traveling on preceding link | |
| (L₁). Deceleration lines 602, 604 and 606 | |
| correspond to defensive, moderate and | |
| aggressive driving styles. | |
| b) The vehicle remains at the slower speed | v_{vehicle} = v_{slow}, for |
| for a period of time (t_{slow}) indicated by the | time t_{slow} |
| number 610 in FIG. 6. | |
| c) The vehicle launches (accelerates) from a | v_{vehicle} = v_{slow} . . . vₗᵢₙₖ₂ |
| slower speed (v_{slow}) to the posted speed limit | |
| vₗᵢₙₖ₂ along the succeeding link (L₂). In this | |
| example, constant acceleration is shown (in | |
| this case for defensive, moderate and | |
| aggressive driving styles at 612, 614 and | |
| 616). | |

Again, the acceleration and deceleration rates do not have to be constant.

In this case νₗᵢₙₖ₂ may be greater than, less than or equal to νₗᵢₙₖ₁ depending on the characteristics of each intersection. The time spent slowing at the intersection, t_{slow}, can also be intersection dependent. However the actual time can vary each instance the vehicle approaches the intersection. An approach for addressing time variations is described by way of an example below. One approach for handling time variations in the route calculation is also discussed below.

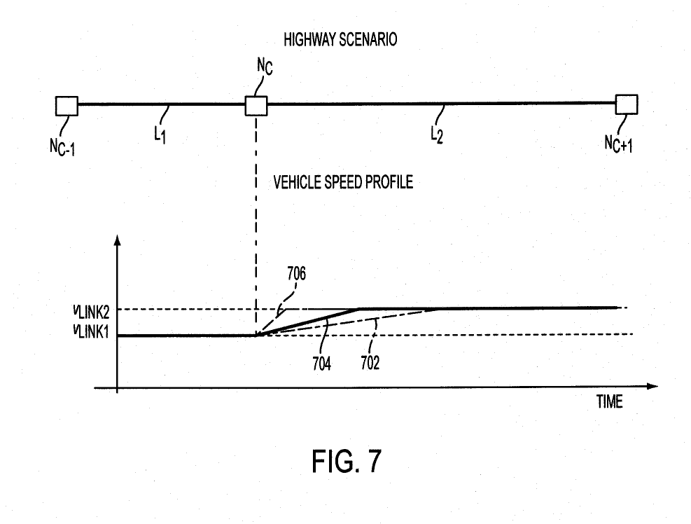

III) Vehicle Speed Change (see FIG. 7)—occurs on streets, roads and highways at locations where the posted vehicle speed limit changes. Changing traffic conditions (e.g., communicated wirelessly to the vehicle) can also result in vehicle speed changes.

| | |
|---|---|
| 1) The vehicle accelerates (increasing speed | v_{vehicle} = vₗᵢₙₖ₁ . . . vₗᵢₙₖ₂ |
| change)/decelerates (decreasing speed | |
| change) when approaching a change in the | |
| posted speed limit, while traveling on the | |
| preceding link (L₁). The | |
| acceleration/deceleration need not be at a | |
| constant rate. In FIG. 7, acceleration from | |
| vₗᵢₙₖ₁ to vₗᵢₙₖ₂ is shown by lines 702, 704 and | |
| 706 for respective defensive, moderate and | |
| aggressive driving style categories. | |

### Time Variations at Intersections

A vehicle speed and travel profile will likely differ each time the vehicle approaches the same intersection. For example the vehicle may have a green light through an intersection and therefore is not required to stop. At other times, the vehicle may reach the same intersection with a red light and will have to wait. This variation is caused by the phase and timing of the traffic signals set up for each intersection and when the vehicle approaches. Similar variations apply to vehicles making a permitted left turn, the timing of which depends on the density of traffic in opposing lanes if there is no left turn signal, or the phasing of the left turn signal if present. This section discusses exemplary methods of handling variations of the vehicle speed and travel profile at such intersections by applying probability techniques.

Traffic is typically managed at a signalized intersection by means of pre-timed controls, which define the timing for each phase, as well as the sequence of all phases which comprises the entire cycle of traffic signals at the intersection. For a desired maneuver through an intersection, the following times can be defined.

| | |
|---|---|
| t_{green} | The duration per cycle in which the desired maneuver has the right |
| | of way (i.e. effective green light). |
| t_{red} | The duration per cycle in which the desired maneuver is not |
| | permitted (i.e. effective red light) |
| t_{cycle} | The total cycle duration, in which t_{cycle} = t_{green} + t_{red} |

For convenience, the “yellow” intersection light can be ignored. One approach for handling yellow lights would be to add one-half of the yellow light duration to t_{red} and one-half to t_{green} on the assumption that early in a yellow light cycle vehicles still pass through the intersection.

Two exemplary vehicle speed and travel scenarios which impact fuel consumption are described as follows:

| | |
|---|---|
| E_{green} | The fuel or energy required for the vehicle to travel through the |
| | intersection node and adjoining links when the light is green. |
| E_{red} | The fuel or energy required for the vehicle to travel through the |
| | intersection node and adjoining links when the light is red. |

The probability of any one of these scenarios occurring can be calculated,

$$PR ( green ) = \frac{{t}_{green}}{{t}_{cycle}}$$

$$PR ( red ) = \frac{{t}_{red}}{{t}_{cycle}}$$

$$Where , PR ( green ) + PR ( red ) = 1.$$

Given the probability and the required fuel for each scenario, the expected value, and the expected amount of energy (representing fuel) consumed for a given maneuver at the intersection, can be calculated.

E(X)=E_{green}·PR(green)+E_{red}·PR(red)

For other traffic maneuvers such as permitted left turns, stop signs and yield signs, a probability density function can be used, which describes the distribution of probable duration values during which the vehicle waits at an intersection node to make a maneuver. From this probability distribution, the expected value for the fuel requirements for a given maneuver can be determined.

### Traffic Flow

Congestion and traffic jams caused by increasing traffic density and decreasing traffic flows increase both fuel consumption and travel time. Acceleration and braking events increase in magnitude and frequency with increasing traffic and average vehicle speeds decrease.

Much research has been devoted to traffic, the most relevant of which focuses on microscopic traffic model development. Some of these models, known as car-following models, describe the motions of individual vehicles in traffic situations based on other vehicles in the immediate vicinity. Such models lend themselves well to the creation of accurate and precise vehicle speed profiles based on traffic states, such as free flow, synchronized flow or congestion conditions. The models can capture acceleration and braking maneuvers associated with the corresponding traffic conditions and can yield more refined vehicle speed profile data for use by a longitudinal vehicle dynamics model. This results in a more accurate determination of fuel consumption and hence makes more accurate predictions on the most fuel efficient route.

One exemplary implementation is the Intelligent Driver Model, a time-continuous, car-following model for the simulation of freeway and urban traffic, described in “Congested Traffic States in Empirical Observations and Microscopic Simulations” (Treiber, Hennecke & Helbing, 2000). The model focuses on the non-linear interaction and dynamics of an individual vehicle in a traffic flow and is comprised of the following two equations:

a) Vehicle Acceleration Equation: The acceleration of a vehicle is a function of the vehicle speed, the gap and the approaching rate (Δv) to the leading vehicle.

$$\dot{v} = a [ 1 - {( \frac{v}{{v}_{o}} )}^{δ} - {( \frac{{s}^{*} ( v , Δ v )}{s} )}^{2} ]$$

b) Desired Minimum Gap Equation: The gap is dynamically calculated based on the current vehicle speed and the approaching rate (Δv)

$${s}^{*} ( v , Δ v ) = {s}_{o} + Tv + \frac{v \cdot Δ v}{2 \sqrt{a \cdot b}}$$

### Traffic Parameters

v Current vehicle speed
s Current bumper-to-bumper gap to leading vehicle
Δv Approaching rate or speed to the leading vehicle
T Headway time to the leading vehicle
vₒ Desired velocity
s*(v, Δv) Desired minimum gap function
sₒ Minimum bumper-to-bumper distance to leading vehicle
a Maximum acceleration
b Desired deceleration
δ Acceleration exponent

These equations can be used to conduct micro-simulations of traffic flows based on a given traffic density (number of vehicles per unit distance) and to derive a vehicle speed profile for the vehicle traveling along a route under specific traffic conditions.

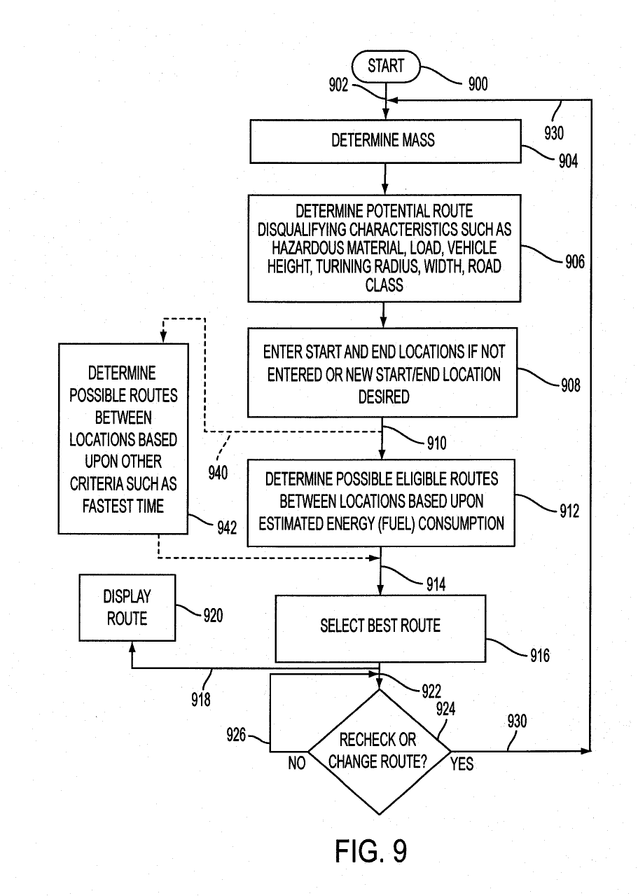

An exemplary usage of a relational map database containing attributes corresponding to energy values for specific links (as well as for nodes) can be understood with reference to FIG. 9. In FIG. 9, the process starts at block 900 and follows a line 902 to a block 904. At block 904 the mass of the actual vehicle is determined. The phrase “determination of the mass” includes determination of an estimate of the mass.

The mass of a vehicle can be determined in a variety of ways. For example, an onboard mass sensor can be used. Alternatively, a mass estimator can be used. As another approach, a vehicle can be weighed with a signal corresponding to the vehicle weight then being provided as a mass indicating input signal. The mass of the vehicle can then be determined by correlating the mass indicating input signal with a value for the mass (using, for example, a lookup table), or by reading the input signal. As yet another approach, a given vehicle type may have an assigned mass or weight which is then adjusted by the weight of any load placed on the vehicle, determined, for example, by weighing the load and from an input signal provided to indicate the load weight.

From block 904, a block 906 is reached at which a determination is made of potential route disqualification characteristics associated with the vehicle. For example, based on the vehicle carrying hazardous material, the vehicle weight exceeding a permitted weight for a link or node, the vehicle height exceeding a height restriction of a link or node such as height limit of a tunnel, turning radius (e.g., the vehicle turning radius is greater than the curvature of a shape point, width, road class (e.g., the vehicle is not allowed to travel on a particular road class)). At block 908, start and end locations are entered into the system by a data entry device (e.g., touchscreen, keyboard, voice entry device, remote data entry via wireless communications or otherwise, mouse, etc.). The start and end locations are typically entered if they have not already been entered, or if a new start/end location is desired. From block 908, a branch 910 is followed to a block 912. At block 912 a determination is made of possible eligible routes between the locations based on estimated energy consumption. Typically a plurality of such eligible routes is considered from a group of near eligible routes. Again, the Dijkstra Algorithm can be used. The possible eligible routes in this example comprise a string of nodes and links that connect between the start and end locations. The start location can simply be the current location of the vehicle, determined, for example, from GPS signals. From block 912, a branch 914 is followed to a block 916 and the best route is selected, in this case based on least energy consumption. Again, the Dijkstra Algorithm can be used. This route can be displayed via a branch 918 to a display 920 (e.g., a screen or other display module, which can be of any type). The route can be displayed where it is visible to a driver of the vehicle and/or remotely to a location such as at a fleet dispatch or management location. The display can be of turn by turn directions, a portion of a map along the route, a complete route, and with zoom in and zoom out features being available if desired.

From block 916, a branch 922 is followed to a block 924. At block 924 a determination is made as to whether the route should be rechecked or changed. For example, the vehicle operator or fleet operator can request a change in the route if unexpected road blockages or slowdowns are encountered or a desired intermediate location becomes known (e.g., a restaurant at a truck stop). This intermediate location can become an end location of the current route and the start location for a route to the original destination. A change can be requested from the next node along the route and a portion of a route can be excluded. For example, links including the next ten miles of a particular freeway can be excluded if current traffic information indicates that the freeway is blocked for that distance by an accident or other blockage. In addition, a route can automatically be rechecked by the system for a better alternative energy efficient route periodically, from time to time, or under predetermined conditions. If a route is recomputed, the starting point is typically the next node along the current route that has yet to be reached by the vehicle. For example, every time the vehicle stops, and/or approaches or reaches each node, the route can be rechecked automatically. If no rechecking or changing the route is to occur, a line 926 can be followed back to line 922 with the process continuing to cycle at this location. If rechecking or a route change is to take place, from block 924, a branch 930 can be followed back to branch 902 and block 904. At block 904 the mass can then be re-determined. Thus, for example, assuming that rechecking automatically takes place every time the vehicle stops, if the vehicle has unloaded a substantial quantity of weight such that the vehicle falls into a different weight category, this would be determined at block 904. Consequently, the vehicle can then be light enough that the best route from an energy usage standpoint now passes over a hill, or over a bridge that previously the vehicle could not travel because the vehicle was too heavy. Weight changes can be ignored in some cases, for example, if the change in weight is less than a predetermined percentage from the prior calculation.

An alternative is also indicated in FIG. 9 between blocks 908 and 912. In this alternative, following block 908, a line 940 is followed to a block 942 at which possible routes between locations are determined based on other criteria, such as a time or distance (e.g., fastest time and/or shortest distance). Branch 940 is followed in addition to the branch through block 912. At block 916, the two results can be compared with the selection being, for example, the most energy efficient route that is within a certain time frame (for example, within a certain percentage of time) of the fastest route. Or the most energy efficient route that does not cause the driver to exceed driving restrictions (such as more than a maximum amount of behind-the-wheel-time in a day).

A more fuel efficient route between two locations is determined from a plurality of possible different routes and displayed. The different routes are made up of links or route segments that begin and end with a node or link transition, each different route comprising at least one different link. In one specific example, a simulation is made utilizing map data, vehicle specific data including mass, and driver driving style characteristics to determine energy values which are stored in association with links and nodes. The stored energy values associated with the links and nodes of plural different routes are then combined such as by summing, to determine a total energy value for each of the plural different routes. A route having a low energy value is then selected with at least a portion of the route being displayed to an operator of a vehicle, whereby the operator of the vehicle can follow the displayed route.

In this description, the terms and/or, when used, means “and”, “or” and both “and” and “or”.

Having described the principles of these developments with reference to a number of embodiments, it should be apparent to those of ordinary skill in the art that these embodiments can be modified in arrangement and detail, without departing from these principles. For example, a non-transitory memory (including, but not limited to, RAM, ROM, Flash memory and other memory, excluding signals) that store a relational map database comprising energy values (which can be represented as fuel values) associated with route segments [e.g., links and/or other route subdivisions (such as nodes)] are included in the inventive aspects of this disclosure. All such modifications are included that fall within the scope of the following claims.

We claim:

1. A method of determining and displaying a more fuel efficient vehicle route between two locations from a plurality of possible different routes, the different routes being made up of links or route segments that begin and end with a node or link transition, each different route comprising at least one different link, the method comprising:
(a) determining one or more energy values for links and nodes that define different routes between the two locations;
(b) storing the energy values associated with each link in association with the respective link and storing the energy values associated with each node in association with the respective node;
(c) summing the stored energy values associated with the links and nodes of plural different routes between the two locations to determine a total energy value for each of the plural different routes;
(d) selecting the route having the lowest total energy value; and
(e) displaying at least portions of the selected route to an operator of a vehicle, whereby the operator of the vehicle can follow the displayed route.

2. A method according to claim 1 wherein the act of determining the one or more energy values for links and nodes comprises determining plural energy values at least for plural selected links that vary, due at least in part to slope changes and traffic controls, with the direction along the link; the act of determining the one or more energy values for links and nodes further comprising determining plural energy values at least for plural selected nodes that vary, due at least to slope changes and traffic controls, with the direction through the node; wherein the act of storing comprises storing respective plural energy values for each of the selected links in association with the selected link and storing respective plural energy values for each of the selected nodes in association with the selected node; and wherein the act of summing comprises summing stored energy values for links and nodes in the direction of a route along the link and through the node.

3. A method according to claim 1 wherein the act of determining the one or more energy values for links and nodes comprises determining plural energy values at least for selected links and plural energy values at least for selected nodes, the determined energy values for said selected links and selected nodes being based in part on an assumed vehicle mass, wherein the act of storing comprises storing respective plural energy values based in part on assumed vehicle mass for each of the selected links in association with the selected link and storing the respective plural energy values based in part on assumed vehicle mass for each of the selected nodes in association with the selected node.

4. The method of claim 3 further comprising determining the mass of a vehicle, and wherein the act of summing comprises summing energy values for links and nodes along a route that include the determined energy values for links and nodes along the route based in part on an assumed vehicle mass that corresponds to the determined vehicle mass.

5. A method according to claim 4 wherein there are categories of assumed vehicle masses, each category being a range of vehicle weights including one category ranging from the weight of an empty unloaded vehicle to a partially full vehicle of a second weight, another category ranging from a third weight to the weight of a vehicle at its maximum gross weighted load, and at least one category between said one and said another category, the assumed vehicle masses being a weight selected from each category, and wherein the assumed vehicle mass corresponds to the determined vehicle mass when the determined vehicle mass is in the category of the assumed vehicle mass.

6. A method according to claim 1 wherein the act of determining one or more energy values for links and nodes comprises determining plural energy values for at least selected links and at least selected nodes based at least in part upon an assumed driving style.

7. A method according to claim 6 further comprising determining the driving style of a vehicle operator, and wherein the act of summing comprises summing energy values for links and nodes along a route that include the determined energy values for links and nodes along the route based in part on an assumed driving style that corresponds to the determined driving style.

8. A method according to claim 7 wherein there are categories of assumed driving styles comprising aggressive, moderate and defensive driving categories, wherein the act of determining the driving style comprises evaluating a driver and assigning a vehicle driver into one of the assumed driving styles with the assumed driving style into which the vehicle driver has been assigned thereby corresponding to the determined driving style.

9. A method according to claim 8 wherein the act of summing comprises summing the stored energy values associated with links and nodes and the selected driving style category of plural different routes between the two locations to determine a total energy value of each of the plural different routes for the driving style category.

10. A method according to claim 1 wherein the act of determining one or more energy values for links and nodes comprises determining plural energy values for at least selected links and at least selected nodes based in part on different traffic densities at different assumed times during a day.

11. A method according to claim 10 wherein the act of storing comprises storing respective plural energy values determined based in part on different traffic densities at different assumed times during a day for each of the selected links in association with the selected link and storing the respective plural energy values determined based in part on different traffic densities at different assumed times during a day for each of the selected nodes in association with the selected node.

12. A method according to claim 10 further comprising determining the expected times that a vehicle traveling along a route will travel along a link or through a node, and wherein the act of summing comprises summing energy values for links and nodes along a route that include the energy values for each link and node along the route determined based in part on a time during the day that corresponds to the expected time that a vehicle traveling along the route will travel along the link and through the node.

13. A method according to claim 1 wherein the act of determining one or more energy values comprises determining a fueling force for each link and node utilizing the following formula:
F_{fuel}=F_{EngFriction}+F_{drag}+Fᵣₒₗₗ+F_{grade}+M_{vehicle}a+F_{Inertial}
, and converting the fueling force for each link and node to an energy value.

14. A method according to claim 13 further comprising expressing the energy value as a fuel quantity.

15. A method according to claim 1 wherein the act of determining one or more energy values comprising determining such values based in part upon an assumed mass of a vehicle and an assumed direction of vehicle travel along a link or through a node, energy values in a direction of travel along a link or through a node varying at least in part due to slope changes and traffic controls, decreasing in a direction that is downhill and increasing at a stop sign.

16. A method according to claim 15 wherein the act of determining one or more energy values comprises determining such values based upon the traffic density at an assumed time of travel along a link and through a node.

17. A method according to claim 16 wherein the act of determining one or more energy values comprises determining such values based upon an assumed driving style of a vehicle operator.

18. A method according to claim 1 wherein the act of storing comprises storing the determined the energy values in a relational map data base as attributes of links and nodes of such database, and wherein the act of summing the stored energy values associated with links and nodes of plural different routes between two locations comprises determining one or more of the mass of the vehicle, the time a link is expected to be traversed or a node is expected to be traversed, the direction of travel along a link or through a node and the driving style of a vehicle operator, and extracting the stored energy values that correspond to these attributes for each link and node along a route and summing the extracted stored energy values for each of the plurality of routes.

19. A method according to claim 1 wherein the act of determining energy values comprises: (a) extracting the links and nodes and selected attributes of the extracted links and nodes for a plurality of routes between two locations from a relational map data base, (b) determining a vehicle speed profile for plural points along a first link included in the plurality of routes, (c) determining an energy value for the first link by simulating the vehicle performance along the first link, (d) determining a vehicle speed profile for travel through a first node included in the plurality for routes, (e) determining an energy value for the first node by simulating the vehicle performance through the first node, and (f) repeating steps (b) and (c) for all of the links included in the plurality of routes and repeating the steps (d) and (e) for all of the nodes included in the plurality of routes.
